(19) United States
(12) Patent Application Publication
(10) Pub. No.: US 2003/0168516 A1
(43) Pub. Date: Sep. 11, 2003

(54) Integrated pool heater control system

(76) Inventor: David J. Cline, Newport Beach, CA (US)

Correspondence Address: Larry K. Roberts, Law Offices of Larry K. Roberts, Inc., P.O. Box 8569, Newport Beach, CA, 92658-8569, US

(21) Appl. No.: 10/382,204

(22) Filed: Mar. 5, 2003

Related U.S. Application Data
(60) Provisional application No. 60/362,205, filed on Mar. 6, 2002.

(51) Int. Cl. B60H 1/02

(52) U.S. Cl. 237/2 A

(57) ABSTRACT

An integrated heater and control system for a pool or spa is described, and includes a housing structure. A heater assembly includes a burner and a heat exchanger, and is disposed within the housing structure. An electronic control system is mounted within or on the housing structure for controlling the heater assembly and pool or spa functions. In one exemplary embodiment, the control system distributes line voltage power and low voltage control signals to one or more external devices, such as a heater circulation pump and a valve.

### CROSS-REFERENCE TO RELATED APPLICATION

This application claims priority from provisional application serial No. 60/362,205, filed Mar. 6, 2002.

### BACKGROUND OF THE DISCLOSURE

In conventional residential pool systems, the pool equipment generally includes a heater pump, a filter, and a control system. Generally, the control system is installed on some type of hard surface, such as an adjacent wall, or on some type of supports specifically constructed to provide a rigid mounting point. The rigid mounting points, whether a wall or a newly installed support, must provide enough elevation to hold the electrical contacts above the ground, protecting them from flooding water, and placing access point within easy reach of service.

Generally, an adjacent electrical service box is provided in which several circuit breakers are provided. These circuit breakers are then electrically connected to relays in the control system housing via conduit. Additional conduits are then installed from the control system housing to the various components of the pool equipment via conduit. This is expensive and time consuming and results in a very complex final installation.

### SUMMARY OF THE DISCLOSURE

An integrated heater and control system for a pool or spa is described, and includes a housing structure. A heater assembly includes a burner and a heat exchanger, and is disposed within the housing structure. An electronic control system is mounted within or on the housing structure for controlling the heater assembly and pool or spa functions. In one exemplary embodiment, the control system distributes line voltage power and low voltage control signals to one or more external devices, such as a heater circulation pump and a valve.

### BRIEF DESCRIPTION OF THE DRAWING

These and other features and advantages of the present invention will become more apparent from the following detailed description of an exemplary embodiment thereof, as illustrated in the accompanying drawings, in which:

FIG. 1 is a diagrammatic view illustrating an exemplary embodiment of an integrated pool heater and control system.

FIG. 1A is a fragmentary view of a pressure connector-type connection for the system of FIG. 1.

FIG. 2 is a side isometric view similar to FIG. 1, but with a side panel of the housing broken away to better illustrate an exemplary heater and control system configuration.

FIG. 2A illustrates an alternate mounting structure for the control system of the system of FIG. 2.

FIG. 3 is a schematic diagram of the system.

FIG. 4 is a simplified top view of elements of the control system mounted in the housing.

### DETAILED DESCRIPTION OF THE DISCLOSURE

In an exemplary embodiment of a pool heater system in accordance with aspects of this invention, the pool heater, which is typically, but not necessarily, gas fired, is usually of some generous size and proportion, and engineered to sit directly on a hard surface, such as a concrete slab. In addition, the heater is usually engineered to withstand direct rain, as found in an outside installation. In addition, the stable construction of the heater is suitable for the mounting and enclosing of electrical control components.

Where a pool is equipped with a heater, there has also been the difficulty of finding appropriate places to connect various temperature sensors, water parameter probes and other sensors. In addition, these connections, if not properly made, can result in improper operation of the pool heater and associated equipment. Performing these installations and connections in the factory insures reliable and proper operation. In addition, simple connection points can be provided within or on the housing, eliminating or reducing the need for an electrician to hook up such things as pumps and blowers.

The total cost of the combined heater/pool control combination can be significantly reduced in exemplary embodiments, as the control housing used in conventional installations is a complex and costly separate enclosure. It should be rain and corrosion proof, be capable of withstanding freezing conditions, direct sunlight, wind, and physical abuse. By incorporating the electrical contents into the heater shell, a much simpler and durable structure is achieved.

In addition, many control functions which are now duplicated between the control and the heater can be eliminated saving money and installation time.

The adjacent electrical box can even be provided with a plug properly weather protected and configured for outdoor service, possibly equipped with a ground fault circuit interrupter, eliminating the need for an electrician to perform complex hook up procedures after the electrical box and plug have been installed.

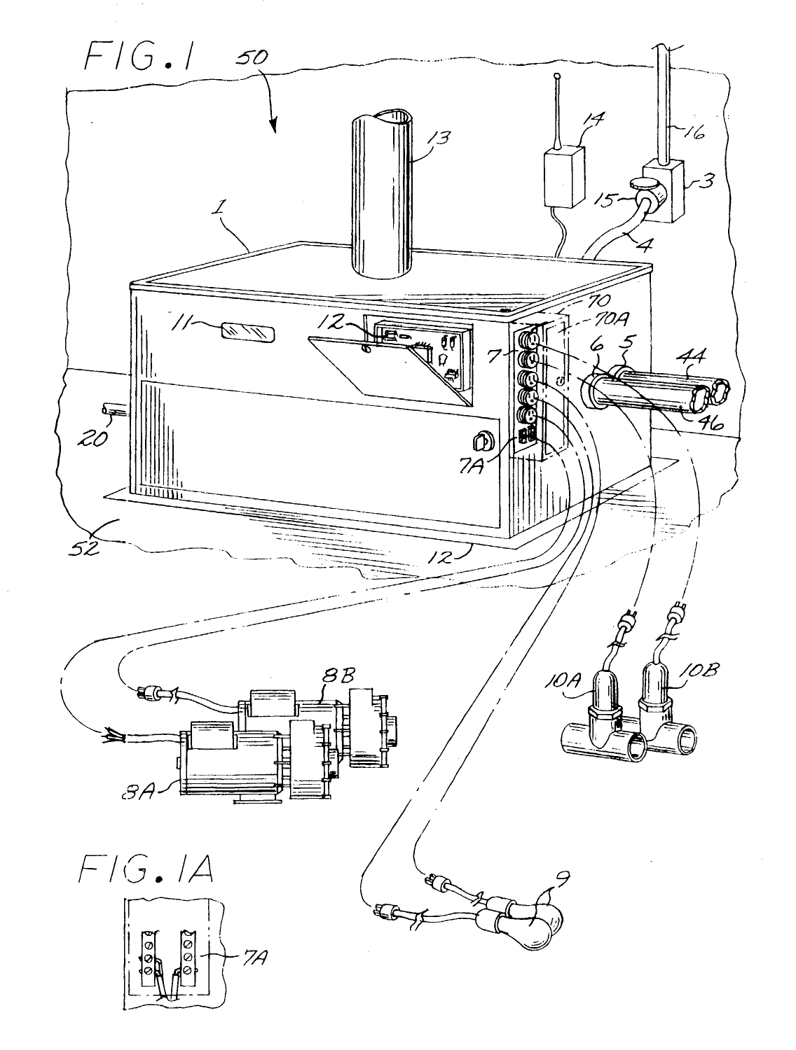

FIG. 1 is a diagrammatic view illustrating an exemplary embodiment of an integrated pool heater and control system 50. The system includes a heater housing 1, which is mounted on a stable base 12, such as a concrete slab, a floor or the like. The base is typically in an exterior location, although the housing could be positioned inside a shed or other enclosure close to the pool. A main power supply connection 3 is provided adjacent the housing location, e.g. mounted on a wall. The main supply connection 3 preferably includes a ground fault circuit interrupter. The heater main power cord 4 is pluggable into the connection 3 as illustrated. A conduit 16 leads to a main power supply, e.g. at a main breaker panel.

The housing 1 supports a water inlet port 5 and a water outlet port 6. Water brought into the housing through the water inlet port 5 is heated by the heater, and the heated water passes out the heater through the outlet port 6 to the pool or spa.

The system 50 further includes electrical connectors or terminals 7, mounted at an accessible location on the housing, for connection to external devices such as pumps 8, pool or spa lights 9 and pool or spa valves. These connectors provide an accessible location to make line power or control line connections to the external devices, preferably in this embodiment without the need for a skilled electrician to make complex wiring connections. The connectors or terminals 7 can be plug connectors, terminal block pressure connectors, or other types of electrical connection means. The connectors or terminals 7 are preferably water-tight connectors or terminals. Pressure connectors 7A are shown in FIG. 1A. Alternatively or in addition, a housing compartment 70 shown in phantom in FIG. 1 can be employed with a door 70A to provide protection against weather and water intrusion. The electrical wiring leading to the external devices can be brought out at openings in the bottom wall of the housing 70, in this exemplary embodiment.

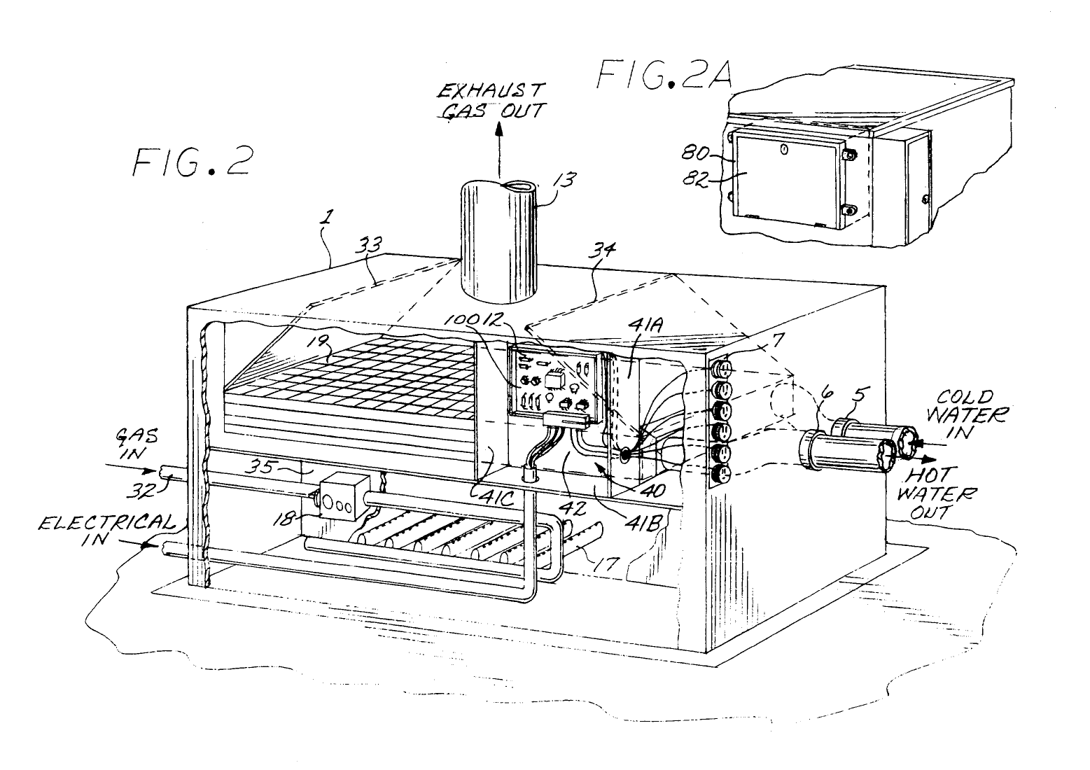

In some installations, an optional wireless receiver or transceiver 14 is connected through the housing to a control system 2 (FIG. 2). This can provide a wireless control link to control the heater and the external devices. The receiver or transceiver can alternatively be mounted within the housing structure 1, with an external antenna connected to the wireless circuit. Thus, the owner or pool operator can remotely control the pool/spa functions using a wireless remote control transmitter, similar to garage door controllers or vehicle security systems. A coded signal can be employed to control the various functions.

In a preferred embodiment, the control system 2 is a microprocessor-controlled system, as described in application Ser. No. 09/451,561, entitled CONTROLLER SYSTEM FOR POOL AND/OR SPA, the entire contents of which are incorporated herein by this reference. This control system distributes line voltage and control signals to the external devices 8-10.

A heater control panel 11 is positioned on an external surface of the housing 1 to provide a means for the operator to locally enter commands to control the system. This can optionally include electronic display functions, e.g. using an LCD panel or the like.

An exhaust gas vent 13 protrudes from a top surface of the housing 1 to vent hot exhaust gasses away from the system.

FIG. 2 is a side isometric view similar to FIG. 1, but with a side panel of the housing broken away to further illustrate an exemplary heater and control system configuration. As illustrated therein, disposed within the housing 1 is the heater gas burner 17, coupled through barrier wall 35 to the gas line 20 through a gas valve 18. A heat exchanger 19 is disposed above the burner 17, through which the water to be heated is circulated via ports 5 and 6. Sheet metal baffles 21 and 22 direct the heat produced by the burner after passing through the heat exchanger upwardly into the vent 13.

The control system 12 is disposed in a compartment defined by metal walls including side walls 41A-C and upright back wall 42; a fourth side wall is defined by the housing itself in this embodiment, although in other embodiments, the compartment can be an integral self-supporting structure such as compartment 80 shown in FIG. 2A, which can allow fabrication of the control system as a separate module which is then installed on or within the housing 1 during the fabrication process. In this case, fasteners such as screws, bolts can be used to secure the compartment, or welding can also be employed. A hinged cover 82 allows access to the control unit, preferably with a lock to prevent unauthorized access.

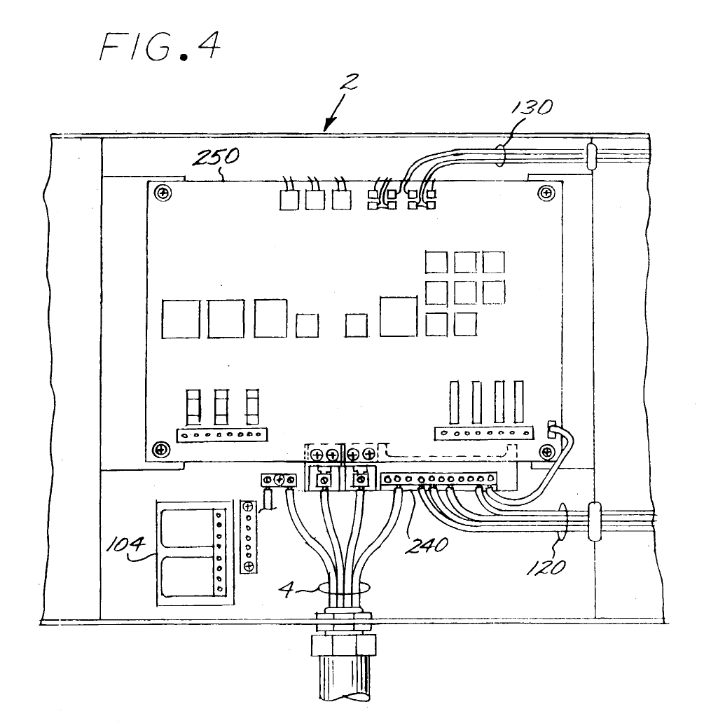

The control system 2 includes a circuit board assembly 250 to which is mounted a terminal block 240 (FIG. 4). Line voltage supply conductors comprising line 4 are connected to the terminal block by pressure connectors. The board assembly 250 includes switches and conductor lines to control line voltage loads and distribute line voltage to the line voltage loads, via conductors connected to terminals on the terminal block 240. The control system board assembly further includes the microprocessor mounted thereon, and switches and signal conductors to control and distribute low voltage signals to control loads and power low voltage loads such as valves.

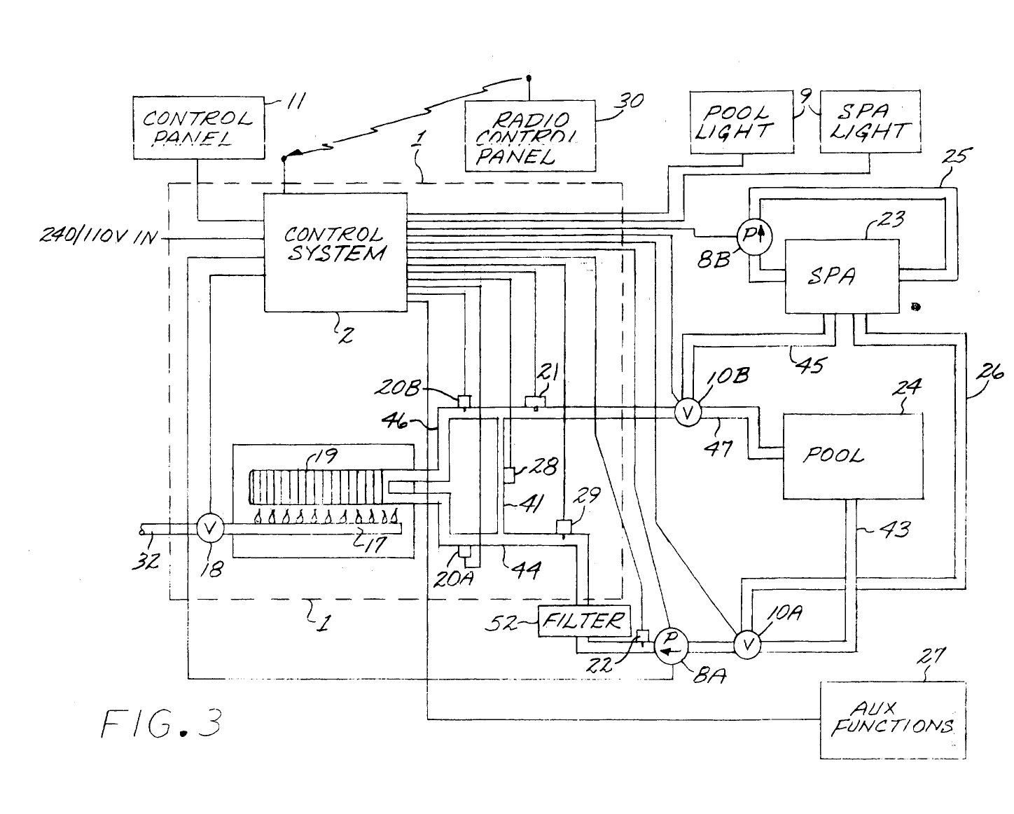

FIG.3 is a schematic block diagram of the system 50. For the exemplary implementation of FIG. 3, both a spa 23 and a pool 24 are supported by the integrated heater/control system 50. Of course, the system could alternatively be employed for pool only or spa only installations. Water is circulated in the spa 23 by a spa jet pump 8B, which is fluidically coupled to water line 25. Line voltage is supplied to the pump 8B from the control system 2, which also includes switches to turn the pump on and off in accordance with the programmed operation of the system. The outlet water line 46 from the heater is passed to a diverter valve 10B to direct the hot water either to spa water line 45 or pool water line 47. The inlet water line 44 to the heater is connected to an outlet of heater circulation pump 8A. The valve 10B is controlled by the control system 2. Line voltage is supplied to the pump 8A from the control system 2, which also includes switches to turn the pump on and off in accordance with the programmed operation of the system. A diverter valve 10A is positioned upstream of the pump 8A to connect either spa water line 26 or pool water line 43 to the heater inlet 44. The valve 10A is controlled by the control system 2.

Temperature sensors 20A and 20B are positioned in the water lines 46, 44 to monitor the water temperature at or near the inlet and outlet ports 5, 6 of the heater system 50, and provide respective sensor signals to the control system 2. A flow sensor 21 is positioned in the hot water line 46, and is sensed or monitored by the control system 2. The sensor 21 allows the control system to know whether water is flowing through the heat exchanger. An optional water pressure transducer 22 is positioned upstream of the filter 52, allowing the control system to determine whether the filter has become clogged.

An oxidation reduction potential (ORP) sensor 29 is fluidically coupled to the cold water line 44 in this exemplary embodiment, and its output signal is passed to the control system 2. A pH sensor 28 is positioned in bypass water line 41 between the lines 44, 46. The diameter of the bypass line 41 is smaller than the diameter of the cold and hot water lines, and so water flows at a substantially reduced rate through the bypass line.

In an exemplary embodiment, the temperature sensors 20A, 20B, the flow sensor 21 and the ORP sensor 29 are mounted within or on the housing structure 1, so that assembly and wiring of these components are performed during the fabrication process for the system.

The control system 2 receives inputs from the control panel 11 as well as from a wireless control panel 30, which can be mounted remotely from the housing 1, e.g. at a convenient location in the pool owner's house. The control system 2 distributes line voltage to the pool and spa lights 9, and includes switches to turn these lights on and off. The control system 2 also is adapted to pass line voltage and/or control signals to other external devices for performing auxiliary functions 27, such as yard lighting functions, filtration pump, pool cleaner, spa blower, water features, and the like. The control system 2 includes a microprocessor programmed to carry out a programmed operation, to control the heater burner through the gas valve 18 and thereby control the water temperature according to a desired manner. Thus, the control system 2 not only controls the heater but also the pool and spa devices as well.

FIG. 4 is a diagrammatic illustration of an exemplary control system 2, which includes a circuit board assembly 250. Line voltage enters the housing 1 through conductor lines 4 and is connected to a connector block 240 mounted to the circuit board 250. Details of an exemplary circuit board assembly and connector 240 are described more fully in the above referenced patent application. The control system 2 distributes the line voltage to line voltage external devices, and also includes a transformer 104 (FIG. 4) to generate low voltage dc signals for controlling some or all of the external devices, as well as provide power to the control system circuitry and microprocessor. Thus, in this exemplary embodiment, line voltage is provided to system 50 through a single line voltage connection, which can be a hard-wired connection, or a plug-in connection. The line voltage wiring to the line voltage loads is illustrated generally as wiring 120 in FIG. 4. Low voltage wiring to low voltage loads is indicated generally as wiring 130.

Some of the advantages of exemplary embodiments of this invention include:

i. a single assembly can be provided which can be electrically connected with one electrical service, thereby reducing installation costs;

ii. a single assembly can be provided which can be electrically connected by a plug, thereby eliminating the need for an electrician at installation;

iii. a single assembly can be provided, into which can be plugged external devices, thereby eliminating the need for an electrician;

iv. all components can be provided in a single housing, thereby allowing factory installation of critical components before delivery to the pool site;

v. the heater can be controlled with a wireless control system, thereby reducing the cost of installation of the pool equipment; and

vi. elimination of duplicate control functions in the heater.

It is understood that the above-described embodiments are merely illustrative of the possible specific embodiments which may represent principles of the present invention. Other arrangements may readily be devised in accordance with these principles by those skilled in the art without departing from the scope of the invention.

What is claimed is:

1. An integrated heater and control system for a pool and/or spa, comprising:
a housing structure;
a gas-fired heater assembly including a burner and a heat exchanger assembly;
an electronic control system for controlling said heater assembly and pool or spa functions, said control system for distributing line voltage power to one or more external devices including a water circulating pump for circulating water through the heater assembly, and for selectively activating said circulating pump to maintain a desired water temperature;
said heater assembly mounted within the housing structure, and said electronic control system mounted within or on the housing structure.

2. The system of claim 1, further comprising:
one or more external electrical connectors mounted at accessable locations on the housing structure for on-site electrical connection to said one or more external devices.

3. The system of claim 2, wherein said one or more external electrical connectors includes a line-voltage plug connector.

4. The system of claim 2, wherein said one or more external electrical connectors includes a pressure connector.

5. The system of claim 1, further comprising a weather housing for covering said external electrical connectors.

6. The system of claim 1, wherein said control system comprises a wireless control system responsive to wireless command signals to control functions of said heater assembly and said one or more external devices.

7. The system of claim 6, wherein the wireless control system includes a receiver responsive to the wireless command signals.

8. The system of claim 7 wherein the wireless command signals are coded command signals, and the receiver is responsive to the coded command signals to decode the coded signals.

9. The system of claim 1, wherein the electronic control system is a microprocessor-controlled system.

10. The system of claim 1, further including an inlet water port for water entering the heater assembly, and an outlet water port for passing water exiting the heater assembly.

11. The system of claim 10, further comprising an oxidation reduction potential (ORP) sensor fluidically coupled to the water entering the heater assembly, the ORP sensor providing an output signal which is passed to the control system.

12. The system of claim 10, further comprising a bypass water line between an inlet water line and an outlet water line, and a pH sensor positioned in the bypass water line for producing a water pH signal passed to the control system.

13. The system of claim 10, further comprising an electronically controlled inlet diverter valve connected to a pool inlet water line from a pool, and to a spa inlet water line from a spa, an output of the diverter valve fluidically coupled to the water inlet port of the heater assembly, and wherein the control system is coupled to the diverter valve to select whether the water entering the heater assembly is from the pool inlet water line or the spa inlet water line.

14. The system of claim 13, further comprising an electronically controlled outlet diverter valve connected to a pool water line from a pool, and to a spa water line from a spa, an input of the diverter valve fluidically coupled to the water output port of the heater assembly, and wherein the control system is coupled to the outlet diverter valve to select whether the water exiting the heater assembly is to be delivered to the pool water line or the spa water line.

15. The system of claim 1, further comprising inlet and outlet water temperature sensors respectively positioned to monitor inlet and outlet water temperatures, and report said temperatures to said control system.

16. The system of claim 1, wherein the control system is disposed in a compartment defined by metal walls within the housing structure.

17. The system of claim 16 wherein said compartment includes side walls and an upright back wall and a bottom wall defined by the housing structure.

18. The system of claim 1, wherein the control system is disposed in a self-supporting compartment structure, which can allow fabrication of the control system as a separate module which is then installed within or on the housing structure during a fabrication process.

19. An integrated heater and control system for a pool and/or spa, comprising:
a housing structure;
a gas-fired heater assembly including a burner and a heat exchanger assembly;
an electronic control system for controlling said heater assembly and pool or spa functions, said control system for distributing line voltage power to one or more external devices including a water circulating pump for circulating water through the heater assembly to maintain a desired water temperature;
said heater assembly disposed within the housing structure, and said electronic control system mounted within or on the housing structure; and
a plurality of sensors having outputs coupled to the control system.

20. The system of claim 19, wherein the plurality of sensors includes a water pH sensor.

21. The system of claim 19, wherein the plurality of sensors includes a oxidation reduction potential (ORP) sensor.

22. The system of claim 19, wherein the plurality of sensors includes at least one water temperature sensor.

23. The system of claim 22, wherein the at least one water temperature sensor includes an inlet water temperature sensor for measuring a temperature of water entering the heater assembly, and an outlet water temperature sensor for measuring a temperature of water exiting the heater assembly.

24. An integrated heater and control system for a pool and/or spa, comprising:
a housing structure;
a gas-fired heater assembly including a burner and a heat exchanger assembly;
an electronic control system for controlling said heater assembly and pool or spa functions, said control system for distributing line voltage power and low voltage control signals to one or more external devices including a water circulating pump for circulating water through the heater assembly;
said heater assembly mounted within the housing structure, and said electronic control system mounted within or on the housing structure.

25. An integrated heater and control system for a pool and/or spa, comprising:
a housing structure;
a gas-fired heater assembly including a burner and a heat exchanger assembly;
an electronic control system for controlling said heater assembly and pool or spa functions, said control system for distributing line voltage power and/or low voltage control signals to one or more external devices including a water circulating pump for circulating water through the heater assembly to maintain a desired water temperature;
said heater assembly disposed within the housing structure, and said electronic control system mounted within or on the housing structure; and
a plurality of sensors having outputs coupled to the control system.
